(19) United States
(12) Patent Application Publication
(10) Pub. No.: US 2009/0013203 A1
(43) Pub. Date: Jan. 8, 2009

(54) Method and apparatus for power saving mode in hard disk drive

(75) Inventors: Chao Yuan Chen, San Jose, CA (US); Michael Sullivan, Fremont, CA (US); Peng Luo, Fremont, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/825,104

(22) Filed: Jul. 2, 2007

(51) Int. Cl. G06F 1/00

(52) U.S. Cl. 713/324

(57) ABSTRACT

A method for implementing a power saving mode in a hard disk drive. The method includes the steps of flying a head over a data track of a disk that is covered with a lubricant. The speed of the disk is reduced. A voltage is applied to a heating element of the head to move the head closer to the disk. The fly height of the head is then determined. The voltage can be incrementally varied until the head makes contact with the disk. The voltage is terminated and the head is allowed to fly over the data track. The head is also moved to adjacent tracks on either side of the data track. A pressure gradient of the flying head moves the lubricant about the disk to mitigate a modulated wear pattern caused by the reduction in disk speed. The disk speed is then increased in a normal operating mode.

### BACKGROUND OF THE INVENTION

1. Field of the Invention

The present invention relates to hard disk drives and a method for minimizing wear patterns created by contact between a head and a disk of the drive in a power saving mode.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

The disks are rotated by a spindle motor of the drive. Rotation of the disks creates an air flow within the disk drive. Each head has an air bearing surface that cooperates with the air flow to create an air bearing between the head and the adjacent disk surface. The air bearing eliminates or minimizes the mechanical wear between the head and the disk. The height of the air bearing is commonly referred to as the fly height of the head.

The magnetic field detected by the head is inversely proportional to the fly height of the head. Likewise, the strength of the magnetic field written onto the disk is also inversely proportional to the fly height. A larger fly height will produce a weaker magnetic field on the disk.

There have been developed heads that contain a heater coil. Current is provided to the heater coil to generate heat and thermally expand the head to move the read and write elements closer to the disk. Heads with heater coils are sometimes referred to as fly on demand (“FOD”) heads. The fly height of FOD heads can be varied by changing the voltage applied to the heater coil.

When a disk drive is in a power savings mode, the head is typically moved to a landing zone. When the drive is powered back up the head is lifted off of the landing zone. Stiction between the head and the disk can cause head degradation and decrease the reliability of the drive.

One solution is to have the head fly over a data track during a power savings mode. The disks are typically covered with an outer layer of lubricant to reduce friction between the heads and the disks. During the power savings mode, the disk speed is reduced. The reduction in disk sped may cause the head to drag along the disk and create undesirable wear of the lubricant. FIG. 1 shows a disk track with a series of modulated wear patterns 1 caused by a head flying over a data track during a power saving mode. The frequency of modulation typically corresponds to the first slider pitch mode of the head. For example, the wear pattern may have a frequency of 200,000. The modulated wear pattern can degrade head-disk interface reliability.

### BRIEF SUMMARY OF THE INVENTION

A method for saving power in a hard disk drive. The method includes flying a head relative to a data track of a disk. The disk speed is then reduced. The head flies over the data track to move lubricant on the disk. The head is also moved to adjacent tracks to move the disk lubricant. The speed of the disk is then increased.

### BRIEF DESCRIPTION OF THE DRAWINGS

FIG. 1 is an illustration of a top surface of a disk of the prior art showing a modulated lubricant wear pattern;

FIG. 2 is a top view of an embodiment of a hard disk drive;

FIG. 3 is a top enlarged view of a head of the hard disk drive;

FIG. 4 is a schematic of the hard disk drive;

FIG. 5 is a flow chart showing a method for reducing power in the disk drive;

FIG. 6 is a graph showing disk speed versus power;

FIG. 7 is an illustration showing a modulated wear pattern of the prior art compared to a modulated wear pattern created with the method described in FIG. 5.

### DETAILED DESCRIPTION

Disclosed is a method for implementing a power saving mode in a hard disk drive. The method includes the steps of flying a head over a data track of a disk that is covered with a lubricant. The speed of the disk is reduced. A voltage is applied to a heating element of the head to move the head closer to the disk. The fly height of the head is then determined. The voltage can be incrementally varied until the head makes contact with the disk. The voltage is terminated and the head is allowed to fly over the data track. The head is also moved to adjacent tracks on either side of the data track. A pressure gradient of the flying head moves the lubricant about the disk to mitigate a modulated wear pattern caused by the reduction in disk speed. The disk speed is then increased in a normal operating mode.

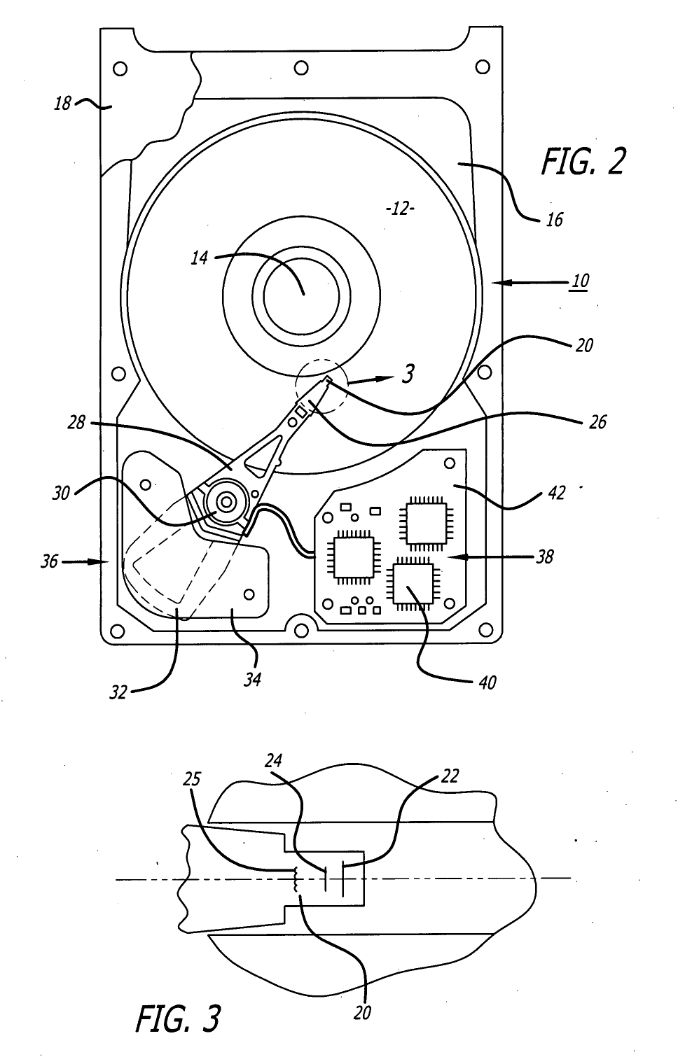

Referring to the drawings more particularly by reference numbers, FIG. 2 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12. The disks 12 are typically covered with an outer layer of lubricant.

The disk drive 10 may include a plurality of heads 20 located adjacent to the disks 12. As shown in FIG. 3 the heads 20 may have separate write 22 and read elements 24. The write element 22 magnetizes the disk 12 to write data. The read element 24 senses the magnetic fields of the disks 12 to read data. By way of example, the read element 24 may be constructed from a magneto-resistive material that has a resistance which varies linearly with changes in magnetic flux. Each head 20 also contains a heater coil 25. Current can be provided to the heater coil 25 to generate heat within the head 20. The heat thermally expands the head 20 and moves the read 24 and write 22 elements closer to the disk.

Referring to FIG. 2, each head 20 may be gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

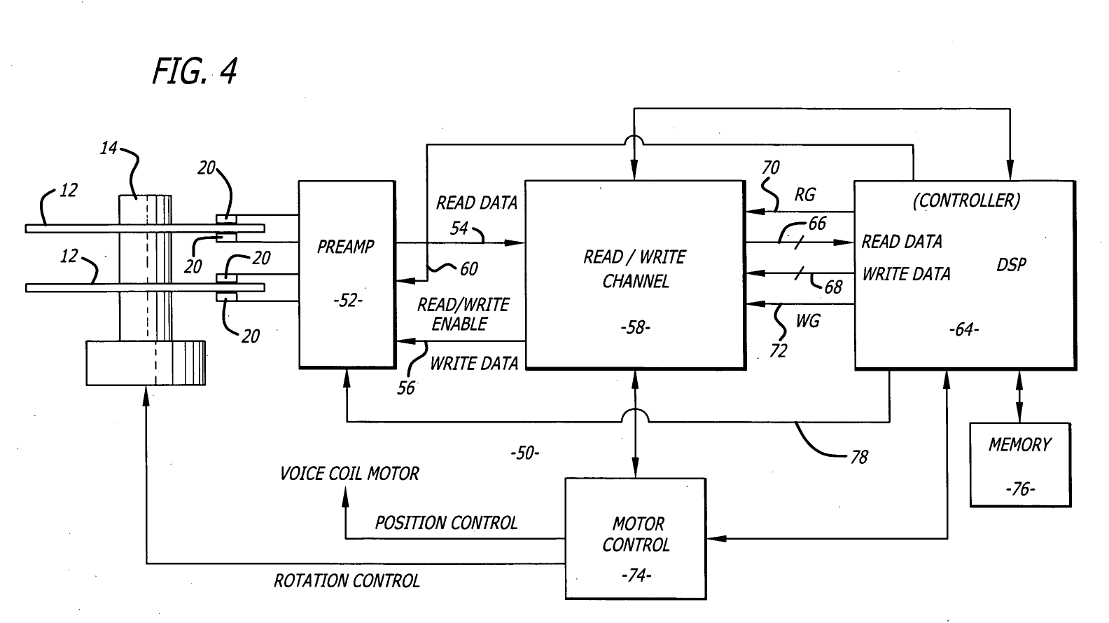

FIG. 4 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 62 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 62 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the instructions to operate the controller and disk drive. Alternatively, the controller may have embedded firmware to operate the drive.

The controller 64 may be connected to the heater coil 25 of each head by line(s) 78 and the preamplifier circuit 52. The controller 64 can provide a current to the heater coil 25 to control the flying height of the head.

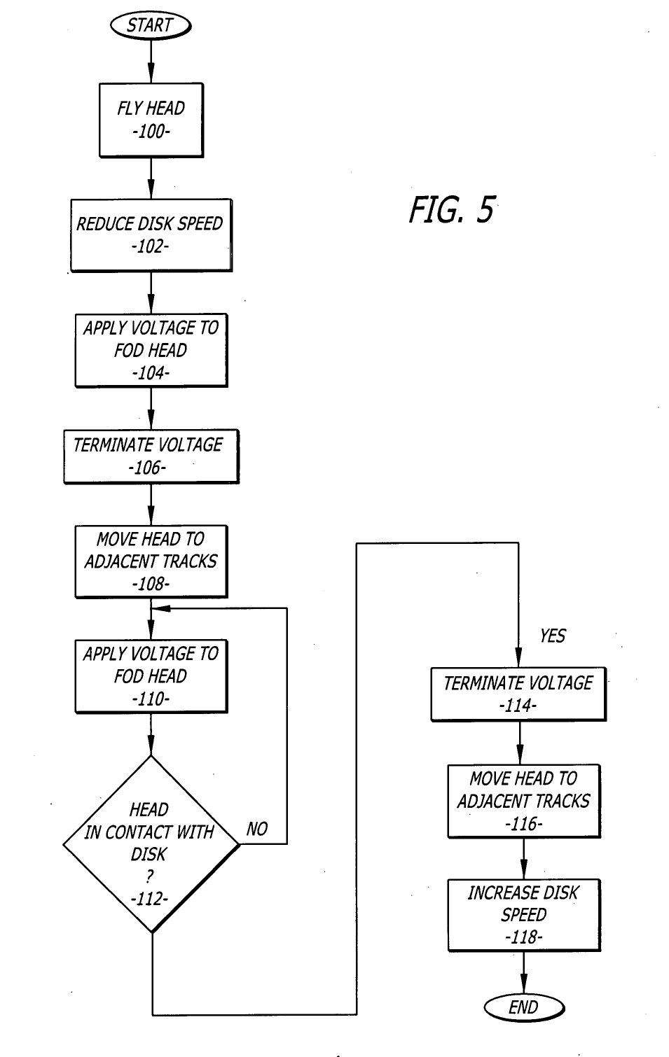

FIG. 5 shows a method for implementing a power savings mode. The power savings mode can be performed in accordance with instructions and data operated on by the controller 64.

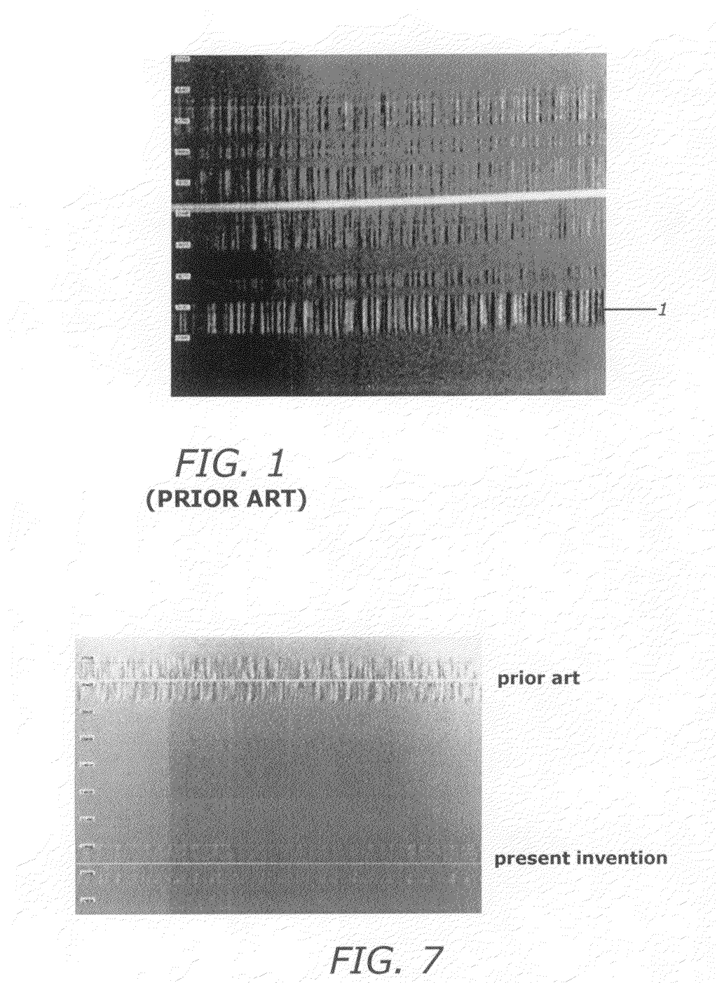

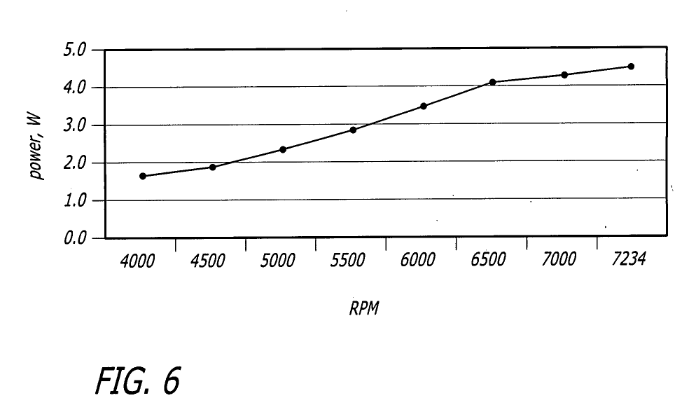

In step 100 the disks of the hard drive are rotated so that the heads fly relative to a data track. In step 102 the speed of the disk is reduced to save power consumption. By way of example, the speed could be reduced from 7200 rpm to 5400 rpm. Such a reduction of power can save approximately 1.5 W. FIG. 6 is a graph showing speed reduction versus power savings. The reduction in disk speed may cause contact between the head and disk and create a wear pattern in the disk lubricant (see FIG. 1).

A voltage is applied to a heating element of a head in step 104. The voltage creates heat and a corresponding thermal expansion of the head. The thermal expansion moves the write and read elements closer to the disk. A signal can be written onto the disk and then read to determine a fly height of the head.

In step 106 the voltage to the heating element is terminated. The head is allowed to fly over the data track. In step 108 the head is moved to adjacent tracks and allowed to fly without a voltage being applied to the heating element. By way of example, the head may be moved +/−1000 adjacent tracks over a 20 second interval.

In step 110 the head is moved back to the data track and another voltage is applied to the heating element and the fly height is again measured. It is determined whether the head makes contact with the disk in decision block 112. The voltage may be increased in 0.1 volt increments until the head is in contact with the disk. The head heating is terminated for a short period after each incremental increase in voltage and the head is flying near the data track to smooth out the lube modulated wear by the pressure of the slider air bearing surface force. Eventually, the touchdown voltage is terminated and the head is allowed to fly over the data track.

In step 114 the voltage is again terminated. The head is moved to adjacent tracks without application of the heating element voltage in step 116. By way of example, the head may be moved +/−1000 tracks for a time period of 20 seconds. The pressure gradient of the head pushes the lubricant around the disk and mitigates the modulated wear pattern normally found on the disks. Flying the head over the data track demodulates the lubricant wear pattern. Flying the head over the adjacent tracks pushes lubricant into the modulated wear area. FIG. 7 is a photograph of a modulated wear pattern of the prior art compared with a wear pattern mitigated by the method of the present invention. It can be seen that the disk surface is less disturbed by the implementation of a power saving mode with the technique of the present invention. The speed of the disk is increased to a normal operating speed in step 118.

Steps 104 through 116 can be repeated after the disk speed is increased. If the track location is randomly selected, then steps 104 through 116 can be repeated for each track location.

The sweep mechanism can be most effective when used at relatively low temperatures when the lube mobility is at relatively lower level. At low temperatures the lubricant may become modulated if head is not moved to adjacent tracks after each increment in voltage and after the final increment. Heating will cause a much higher pole-tip protrusion, and will produces a higher pressure gradient. The pressure gradient generates higher lube depletion forces to modulate the lubricant corresponding with a slider vibration pitch mode.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for saving power in a hard disk drive, comprising:
rotating a disk covered with a lubricant, wherein a head flies relative to a data track of the disk;
reducing the speed of the disk;
flying the head over the data track to move the lubricant on the disk;
moving the head to a plurality of adjacent tracks to fly over the adjacent tracks and move the lubricant on the disk; and,
increasing the speed of the disk.

2. The method of claim 1, wherein the head is moved to a plurality of +/−N number of tracks about the data track.

3. The method of claim 2, wherein the head is moved +/−1000 tracks in a 20 second time interval.

4. The method of claim 1, further comprising applying a voltage to a heating element of the head to move the head into contact with the disk.

5. The method of claim 4, further comprising terminating the voltage to the heating element before moving the head to the plurality of adjacent tracks to move the lubricant on the disk.

6. The method of claim 5, further comprising performing the steps of flying the head over the data track and said adjacent tracks after the disk speed is increased.

7. A hard disk drive, comprising:
a disk with a lubricant and a data track;
a spindle motor coupled to said disk;
a head coupled to said disk, said head having a write element, a read element and a heater coil;
an actuator coupled to said head;
a voice coil motor coupled to said actuator; and,
a controller circuit that causes; said disk to rotate relative to a head so that said head flies relative to said data track, a reduction in a speed of said disk, said head to fly over said data track to move said lubricant on said disk, and movement of said head to a plurality of adjacent tracks to fly over said adjacent tracks and move said lubricant on said disk.

8. The disk drive of claim 7, wherein said controller circuit causes said head to move to a plurality of +/−N number of tracks about said data track.

9. The disk drive of claim 8, wherein said controller circuit causes said head to move +/−1000 tracks in a 20 second time interval.

10. The disk drive of claim 7, wherein said controller circuit causes an application of a voltage to said heating element to move said head into contact with said disk.

11. The disk drive of claim 10, wherein said controller circuit causes; a termination of said voltage to said heating element before said a movement of said head to said plurality of adjacent tracks to move said lubricant on said disk.

12. The disk drive of claim 11, wherein said controller causes said head to fly over said data track and said adjacent tracks after said disk speed is increased.

13. A hard disk drive, comprising:
a disk with a lubricant;
a spindle motor coupled to said disk;
a head coupled to said disk, said head having a write element, a read element and a heater coil;
an actuator coupled to said head;
a voice coil motor coupled to said actuator; and,
controller means for causing; said disk to rotate relative to a head so that said head flies relative to a data track, a reduction in disk speed, said head to fly over said data track to move said lubricant on said disk, said head to move to a plurality of adjacent tracks to fly over said adjacent tracks and move said lubricant on said disk.

14. The disk drive of claim 13, wherein said controller means causes said head to move to a plurality of +/−N number of tracks about said data track.

15. The disk drive of claim 14, wherein said controller means causes said head to move +/−1000 tracks in a 20 second time interval.

16. The disk drive of claim 13, wherein said controller means causes an application of a voltage to said heating element to move said head into contact with said disk.

17. The disk drive of claim 16, wherein said controller means causes a termination of said voltage to said heating element before said movement of said head to said plurality of adjacent tracks to move said lubricant on said disk.

18. The disk drive of claim 17, wherein said controller causes said head to fly over said data track and said adjacent tracks after said disk speed is increased.
